(19) United States
(12) Patent Application Publication
(10) Pub. No.: US 2026/0253264 A1
(43) Pub. Date: Aug. 27, 2026

(54) ENERGY-EFFICIENT DIFFUSION MODEL ACCELERATOR FOR TEXT-BASED IMAGE GENERATION

(71) Applicant: Korea Advanced Institute of Science and Technology, Daejeon (KR)

(72) Inventors: Hoi Jun YOO, Daejeon (KR); Ji Won Choi, Daejeon (KR)

(73) Assignee: Korea Advanced Institute of Science and Technology, Daejeon (KR)

(21) Appl. No.: 19/192,337

(22) Filed: Apr. 29, 2025

(30) Foreign Application Priority Data
Feb. 21, 2025 (KR) 10-2025-0022775

(51) Int. Cl. G06T 11/00; G06F 9/30; G06V 10/82

(52) U.S. Cl. CPC G06T 11/00; G06F 9/30007; G06V 10/82

(57) ABSTRACT

An energy-efficient diffusion model accelerator for text-based image generation includes a dual-mode bit-slice core cluster configured to perform operations on all linear layers included in UNet, which is a network used in a diffusion model that generates an image based on text description, an attention core configured to perform all attention operations included in UNet, a single instruction multiple data core configured to perform activation function, on-chip quantization, and group normalization, a patch-wise similarity-based XOR unit configured to compress a self-attention score, an important pixel spotting unit configured to spot an important pixel based on given text, a global memory configured to store an input value and an output value between adjacent layers, a top controller configured to assign and schedule computational workloads to the DBSC cluster and the attention core, and a network-on-chip configured to enable data movement between the DBSC clusters, the attention core, and the global memory.

### CROSS-REFERENCE TO RELATED APPLICATION

This application claims the benefit of priority under 35 U.S.C. § 119(a) to Korean Patent Application No. 10-2025-0022775, filed on Feb. 21, 2025, the entire contents of which are incorporated herein by reference.

### ACKNOWLEDGEMENT

[Project Unique Number] 2710008175
[Project Number] 00256472
[Ministry] Ministry of Science and ICT
[Project Managing Institution] Institute of Information & Communications Technology Planning & Evaluation (IITP)
[Program Name] ICT Broadcasting Innovation Talent Development
[Project Title] Graduate School of AI Semiconductor (KAIST)
[Contribution Rate]: 50%
[Project Executing Institution] Korea Advanced Institute of Science Technology
[Project Period] 2024-01-01 ~2024-12-31

### Acknowledgment Statement

This work was supported by the Institute of Information & Communications Technology Planning & Evaluation (IITP) under the artificial intelligence semiconductor support program to nurture the best talents (IITP-2024-RS-2023-00256472) grant funded by the Korea Government (MSIT).
[Project Unique Number] 2710008706
[Project Number] 2022-0-01170
[Ministry] Ministry of Science and ICT
[Project Managing Institution] Institute of Information & Communications Technology Planning & Evaluation (IITP)
[Program Name] PIM Artificial Intelligence Semiconductor Core Technology Development
[Project Title] PIM Semiconductor Design Research Center
[Contribution Rate]: 50%
[Project Executing Institution] Korea Advanced Institute of Science Technology
[Project Period] 2022.04.01-2028.12.31

### Acknowledgment Statement

This work was supported by Institute of Information & communications Technology Planning & Evaluation (IITP) grant funded by the Korea government (MSIT) (2022-0-01170, PIM Semiconductor Design Research Center)

### BACKGROUND OF THE INVENTION

### Field of the Invention

The present invention relates to an energy-efficient diffusion model accelerator for text-based image generation, and more particularly to an energy-efficient diffusion model accelerator for text-based image generation capable of significantly expanding a possibility of supporting various generation models as well as high-quality image generation via a diffusion model on a mobile device.

### Description of the Related Art

The demand for generative AI has recently skyrocketed due to excellent quality. In the field of image generation, several models exhibiting higher quality and performance have been proposed as alternatives to traditional generative models. A diffusion model has emerged as a powerful solution in image synthesis and has been widely adopted commercially. The diffusion model exhibits excellent performance in generating images based on text descriptions, allowing users to obtain intended images from text queries.

A process of processing a diffusion model includes three steps, namely, a text encoding process, an image generation process through iterative denoising, and an image decoding process for obtaining a final image.

UNet, which is a network used in the diffusion model, includes a plurality of blocks and residual connections, and each block includes a convolutional neural network (CNN) stage and a transformer stage.

The CNN stage includes two CNN layers, and the transformer stage includes a self-attention layer, a cross-attention layer, and a feed forward network (FFN) layer.

The cross-attention layer integrates text information during a denoising process through attention calculation.

Using UNet for image generation exhibits excellent image quality by alternating between CNN and transformer stages, but has the problem that application to mobile devices is difficult due to the inherent characteristics of the model.

To efficiently use the diffusion model on mobile devices, two major challenges need to be addressed in terms of memory access and computational load.

First, attention calculation in the transformer stage requires frequent external memory access. Since self-attention captures a spatial correlation of an image in units of pixels, a calculation result thereof requires an exponentially increasing frequency of external memory access.

Second, the computationally intensive repetitions of UNet impose excessive computational load. Even though a CNN and a transformer share the total computational load in similar proportions, mixed-precision optimization for the CNN has been widely used in existing technologies. However, a transformer block of UNet, especially an FFN layer following the self-attention layer, still remains as an unsolved problem.

(Non-patent literature 1) [1] I. Goodfellow, J. Pouget-Abadie, M. Mirza, B. Xu, D. Warde-Farley, S. Ozair, A. Courville, and Y. Bengio, “Generative adversarial networks,” Communications of the ACM, 63(11), 2020, pp. 139-144.

(Non-patent literature 2) [2] A. Brock, J. Donahue, and K. Simonyan, “Large Scale GAN Training for High Fidelity Natural Image Synthesis,” in International Conference on Learning Representations, 2018. [3] X. Yan, J. Yang, K. Sohn, and H. Lee, “Attribute2image: Conditional image generation from visual attributes, ” in European Conference on Computer Vision, pp. 776-791, Springer, 2016.

(Non-patent literature 3) [4] A. Razavi, A. Van den Oord, and O. Vinyals, “Generating diverse high-fidelity images with vq-vae-2,” Advances in neural information processing systems, 32, 2019.

(Non-patent literature 4) [5] J. Ho, A. Jain, and P. Abbeel, “Denoising diffusion probabilistic models,” Advances in neural information processing systems, 33, 2020, pp. 6840-6851.

(Non-patent literature 5) [6] R. Rombach, A. Blattmann, D. Lorenz, P. Esser, and B. Ommer, “High-resolution image synthesis with latent diffusion models,” in Proceedings of the IEEE/CVF conference on computer vision and pattern recognition, 2022, pp. 10684-10695.

### SUMMARY OF THE INVENTION

Therefore, the present invention has been made in view of the above problems, and it is an object of the present invention to provide an energy-efficient diffusion model accelerator for text-based image generation capable of achieving significantly reduced external memory access energy by augmenting sparsity of a self-attention score using patch-wise similarity of an image, enabling performance of low-precision calculation based on text-based important pixel information spotting, and providing high energy efficiency through a bit-slice core architecture supporting this calculation.

It is another object of the present invention to provide an energy-efficient diffusion model accelerator for text-based image generation capable of effectively compressing a self-attention score to reduce external memory access resulting therefrom.

It is a further object of the present invention to provide an energy-efficient diffusion model accelerator for text-based image generation capable of improving energy efficiency by using mixed precision to reduce computational energy of an FFN layer, which accounts for a largest portion of the total computational load of the diffusion model.

It is a further object of the present invention to provide an energy-efficient diffusion model accelerator for text-based image generation capable of achieving high energy efficiency by supporting a dual operator method, i.e., both input-fixed operation and weight-fixed operation, to reduce the number of times of internal memory access since an operator having a high reuse rate among input and weight varies for each layer included in the diffusion model.

In accordance with the present invention, the above and other objects can be accomplished by the provision of an energy-efficient diffusion model accelerator for text-based image generation including a dual-mode bit-slice core (DBSC) cluster configured to perform operations on all linear layers included in UNet, which is a network used in a diffusion model that generates an image based on text description, an attention core configured to perform all attention operations included in UNet, a single instruction multiple data (SIMD) core configured to perform activation function, on-chip quantization, and group normalization, a patch-wise similarity-based XOR unit (PSXU) configured to compress a self-attention score, an important pixel spotting unit configured to spot an important pixel based on given text, a global memory configured to store an input value and an output value between adjacent layers, a top controller configured to assign and schedule computational workloads to the DBSC cluster and the attention core, and a network-on-chip configured to enable data movement between the DBSC clusters, the attention core, and the global memory.

UNet used for a denoising process may include a plurality of blocks and residual connections, each of the blocks may include a CNN layer and a transformer layer, the CNN layer includes two CNN layers, and the transformer layer may include a self-attention layer, a cross-attention layer, and a feed forward network layer.

When an input feature map of the self-attention layer is converted into a query and a key, the PSXU may compress a self-attention score generated through a pixel-wise self-attention operation between one row of the query and one row of the key.

The PSXU may prune a value of the self-attention score in an unstructured manner using a predefined fixed threshold, then increase bitmap sparsity by applying XOR operation to an adjacent bitmap patch in a horizontal direction of a pruned self-attention score bitmap, and compress the self-attention score through compressed sparse row encoding.

The PSXU may include a bitmap generator unit including a plurality of bitmap generators each for generating a bitmap of predetermined bits, a reconfigurable XOR unit (RXU) configured to generate a sparsity-augmented bitmap using the bitmap of the predetermined bits, and a compressed sparse row encoder configured to perform compressed sparse row encoding on the sparsity-augmented bitmap.

When an input feature map of the cross-attention layer is converted into a query and a key, the important pixel spotting unit may determine a relative importance of a pixel for the text by comparing a special classification token attention score for each pixel query among the special classification token attention score and a text token attention score separated from a cross-attention result for each pixel query and text key by the cross-attention layer.

When the special classification token attention score of the pixel query is less than a predefined threshold, the important pixel spotting unit may spot the pixel as an important pixel.

As a result of the cross-attention result, the important pixel spotting unit may consider a spotted pixel important to assign the pixel with high precision and consider a pixel that is not spotted unimportant to assign the pixel with low precision.

The important pixel spotting unit may assign precision to input of the feed forward network layer by text-based important: pixel spotting so that mixed-precision processing is allowed in the feed forward network layer.

A DBSC of the DBSC cluster may include a plurality of processing element columns, each of the processing element columns may include a plurality of processing elements, a plurality of adder trees, and a bit-slice adder, and both an input-stop mode and a weight-stop mode may be supported according to operational characteristics of the CNN and transformer layers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram for describing an overall operation sequence of a diffusion model for text-based image generation;

FIG. 2 is a diagram for describing two challenges to be solved to accelerate the diffusion model;

FIG. 3 is an overall configuration diagram of an energy-efficient diffusion model accelerator for text-based image generation according to the present invention;

FIG. 4 is a diagram of an entire process of sparsity augmentation using patch-wise similarity proposed to reduce external memory access of a self-attention score according to the present invention;

FIG. 5 is a diagram of hardware for sparsity augmentation using patch-wise similarity proposed in the present invention;

FIG. 6 is a diagram of an entire process of text-based important pixel spotting proposed by the present invention;

FIG. 7 is a diagram of hardware for text-based important pixel spotting proposed in the present invention;

FIG. 8 is a diagram of a bit slice core architecture that supports mixed precision and dual operator fixed operation proposed in the present invention; and

FIG. 9 is a diagram illustrating a result and accuracy of performance of text-based image generation using the diffusion model accelerator proposed in the present invention.

### DETAILED DESCRIPTION OF THE INVENTION

Terms or words used in this specification and claims should not be interpreted as limited to usual or dictionary meanings thereof, but should be interpreted as having meanings and concepts that conform to the technical idea of the present invention, based on the principle that the inventor may appropriately define the concept of a term to best describe the invention.

Therefore, the embodiments described in this specification and the configurations illustrated in the drawings are only the most preferred embodiments of the present invention and do not represent all of the technical ideas of the present invention. Therefore, it should be understood that there may be various equivalents and modified examples that may replace the embodiments and configurations at the time of filing this application.

Hereinafter, an energy-efficient diffusion model accelerator for text-based image generation according to the present invention will be described in detail with reference to the attached drawings.

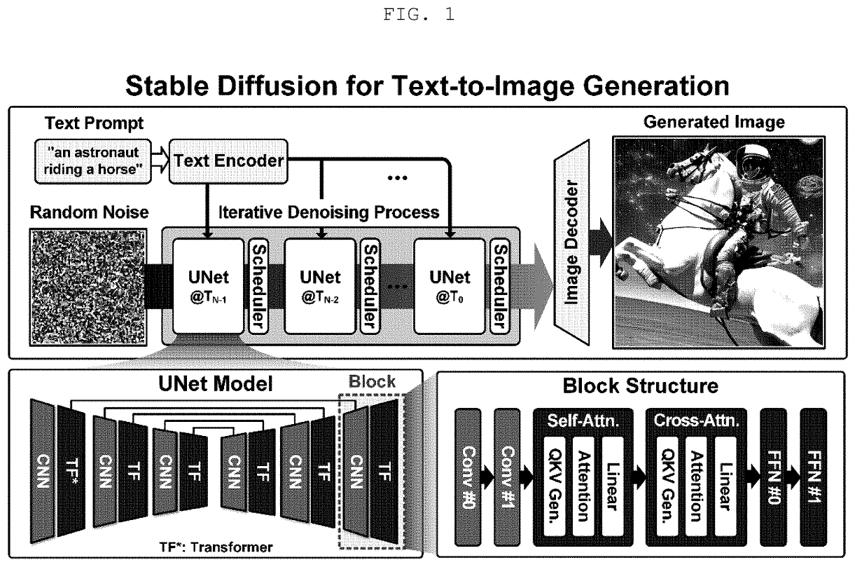

FIG. 1 illustrates an overall operation sequence of the diffusion model for text-based image generation.

A process of processing the diffusion model includes three main steps, namely, a text encoding step, an image generation step through iterative denoising, and an image decoding step for obtaining a final image.

Among the three main steps, the image generation step corresponding to a second step is a step that requires the most computational load and memory access in the entire diffusion model due to the iterative denoising process for image generation.

Therefore, the present invention proposes a method for accelerating the second step.

UNet, which is an AI model structure used for the denoising process, includes several blocks and residual connections. Each UNet block includes a CNN and a transformer stage, where the CNN stage includes two CNN layers, and the transformer stage includes a self-attention layer, a cross-attention layer, and an FEN layer. The cross-attention includes text information in the denoising process through attention calculation.

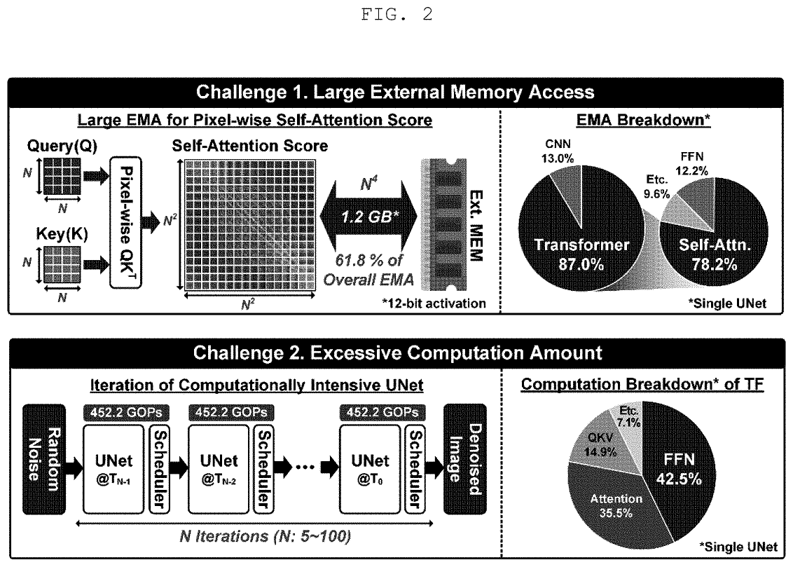

FIG. 2 illustrates two challenges that need to be addressed to accelerate the diffusion model. When UNet is as a backbone, the CNN and transformer stages are alternately used to exhibit excellent image quality. However, use on mobile devices is limited due to the inherent characteristics of the model.

To efficiently use the diffusion model on mobile devices, two major challenges need to be addressed in terms of memory and computational requirements.

First, attention calculation in the transformer stage generates significantly frequent external memory access. When 12-bit input activation and 8-bit weight precision are used, single UNet iteration requires 1.9 GB of external memory accesses.

87.0% of the total external memory access is required in the transformer stage of single UNet, and the self-attention (SA) layer in the transformer accounts for 78.2% of the external memory access. Since the self-attention (SA) layer operates in units of pixels to capture a spatial correlation of an image, a self-attention score causes exponentially increasing external memory access, which accounts for 61.8% of the total external memory access.

Second, excessive computational load is required due to repetition of UNet involving a lot of operations. A CNN and a transformer share the total computational load in similar proportions. However, while optimization for mixed precision of the CNN has already been widely confirmed, optimization for a transformer block of UNet, especially an FFN layer following the cross-attention layer, remains a challenge. In the transformer stage, the FFN layer accounts for 42.5% of the total computational load.

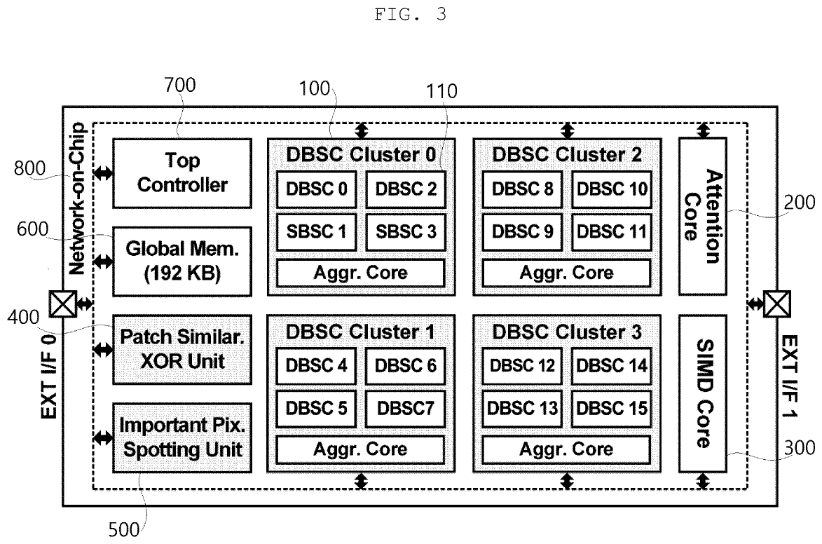

FIG. 3 is a configuration diagram of the energy-efficient diffusion model accelerator for text-based image generation according to the present invention.

As illustrated in FIG. 3, the energy-efficient diffusion model accelerator for text-based image generation according Substitute Specification (clean copy) to the present invention includes four dual-mode bit-slice core (DBSC) clusters 100, an attention core 200, a single instruction multiple data (SIMD) core 300, a patch-wise similarity-based XOR unit (PSXU) 400, an important pixel spotting unit (IPSU) 500, a 192 KB-global memory 600, a top controller 700, and a 2D mesh-type network-on-chip 800.

Each of the DBSC clusters 100 is hardware that performs operations on all linear layers (matrix multiplication of input and weight) included in UNet.

The DBSC cluster 100 includes four DBSCs 110 and one aggregation core 120.

Each of the DBSCs 110 includes a 16×16-processing element (PE) array 111, a 6 kB-input memory IMEM 112, a 2.25 kB-weight memory (WMEM) 113, and a 12 kB-output memory (OMEM) 114.

The DBSC 110 supports a dual-stop mode to optimize data reusability.

The DBSC 110 supports an input-stop mode in the CNN stage and a weight-stop mode in the transformer stage.

The aggregation core 120 accumulates partial sums generated from the four DBSCs 110 to generate final output.

The attention core 200 is hardware that performs all attention operations included in UNet.

The attention core 200 supports input skipping to efficiently process self-attention and cross-attention layers using a compressed sparse row (CSR) decoder.

The SIMD core 300 performs an activation function, on-chip quantization, and group normalization.

The PSXU 400 effectively compresses self-attention scores to reduce external memory access.

The IPSU 500 spots an important pixel based on given text to enable mixed-precision FFN layer operations.

The 192 KB-global memory 600 stores an input value and an output value between adjacent layers to assist in reducing external memory access.

The top controller 700 assigns and schedules computational workloads to the DBSC cluster 100 and the attention core 200.

The network-on-chip 800 functions to enable data movement between the DBSC clusters 100, the attention core 200, and the global memory 600.

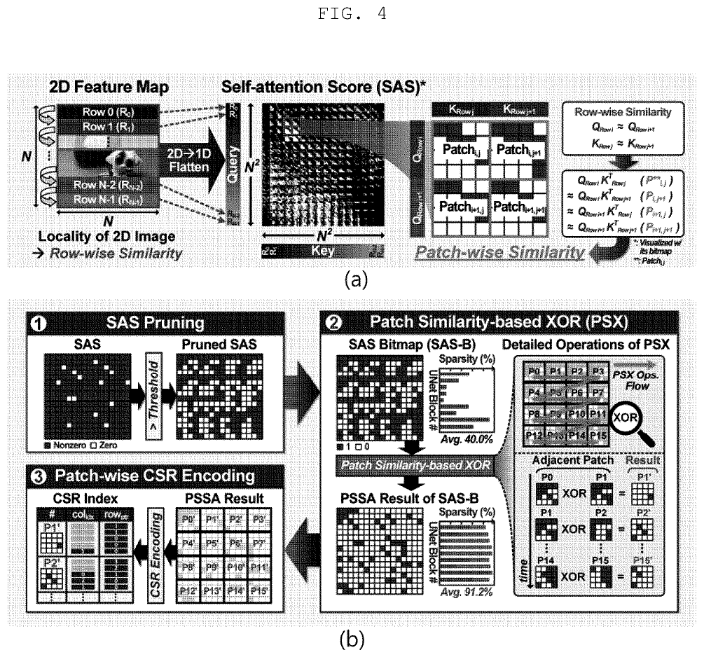

FIG. 4 illustrates patch-wise similarity in the self-attention score. Due to spatial locality between pixels, a 2D input feature map of the self-attention layer represents similarity between adjacent rows.

When the input feature map is converted into a query and a key, this is flattened row-wise in a 1D format and a pixel-wise self-attention operation is performed.

As a result, as illustrated in FIG. 4A, a self-attention core patch generated through attention calculation between one row of f the query and one row of the key represents similarity between adjacent patches.

As illustrated in FIG. 4B, a process of compressing the self-attention core includes three steps.

A first step is self-attention score pruning, which prunes self-attention score values in an unstructured manner using a predefined fixed threshold.

A second step is patch similarity-based XOR.

Since the pruned self-attention score and a bitmap thereof represent patch-wise similarity, bitmap sparsity is increased by applying an XOR operation to adjacent bitmap patches in a horizontal direction of the pruned self-attention score bitmap.

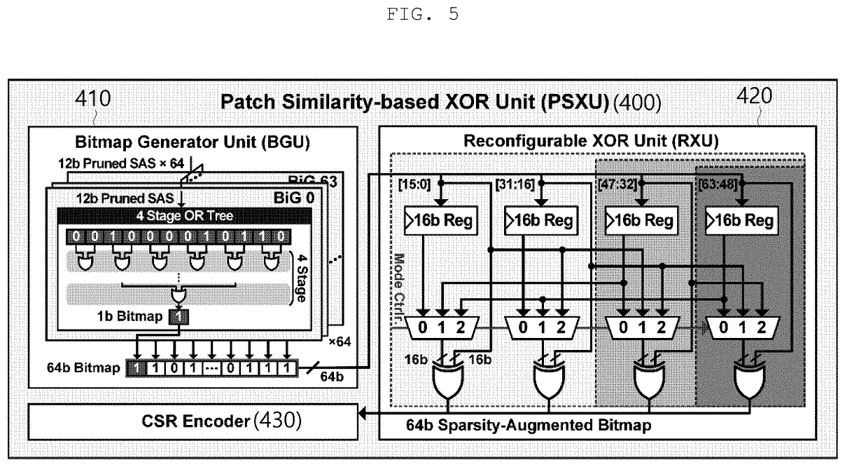

A third step is patch-wise compression using csr encoding. Local CSR encoding for each patch yields a higher compression ratio than global CSR encoding for the entire self-attention score bitmap since encoding overhead of CSR decreases as a target size decreases.
FIG. 5 illustrates the PSXU 400 enabling proposed patch similarity-based sparsity augmented DMF.

The PSXU 400 includes a bitmap generator unit (BGU) 410 including 64 bitmap generators (BiGs) 411, a reconfigurable XOR unit (RXU) 420 that supports different patch sizes, and a CSR encoder 430.

Since each block of the UNet structure requires different token lengths for queries and keys in the self-attention layer, the patch sizes vary among three cases, namely, 16×16, 32×32, and 64×64.

The PSXU 400 receives 64 pieces of data from one row of the self-attention scores as input, and the BGU 410 generates a 64-bit bitmap.

The generated 64-bit bitmap is transmitted to the RXU 420.

A mode control signal that controls four 3×1-MUXs in the RXU 420 causes the RXU 420 to operate as an RXU for a single 64-bit patch, two adjacent 32-bit patches, and four adjacent 16-bit patches.

A sparsity-augmented bitmap generated by the RXU 420 is transmitted to the CSR encoder 430.

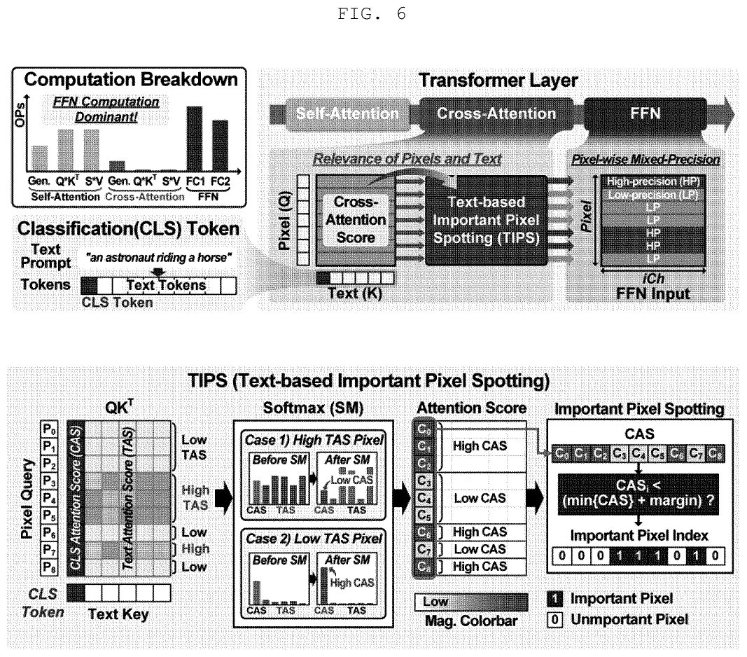

FIG. 6 is a diagram of an entire process of text-based important pixel spotting that is proposed.

To reduce dominant computational power of the FFN layer, attention is paid to a cross-attention layer prior to the FFN layer.

Text-based important pixel spotting (TIPS) proposed by the IPSU 500 is derived from a property that cross-attention determines an importance of a pixel related to given text.

A pixel having low importance may be assigned with lower precision after a cross-attention operation. In this way, a mixed-precision operation may be performed in the FFN layer. In the cross-attention and FFN layers, operations between different pixel tokens do not mix, and thus low-precision workload may be effectively assigned across the FFN layer.

In the cross-attention, text keys may be classified into a special classification token and a text token, and the special classification token is placed as a first token to capture global context of a sentence.

A cross-attention result for each pixel query and text key is separated into a special classification token attention score (CLS token attention score (CAS) ) and a text token attention score (TAS).

A pixel query highly relevant to a text key tends to have a higher TAS to reflect details of given text.

A subsequent softmax layer normalizes a score of each query, and thus scales of the TAS and the CAS are inversely proportional.

That is, as the CAS decreases, the TAS increases.

By comparing the CAS for each pixel query, it is possible to determine relative importance of a pixel for the corresponding text.

When the CAS of the pixel query is less than a predefined threshold, the corresponding pixel is spotted as an important pixel and an index thereof is stored.

A cross-attention result of the spotted pixel is assigned with high precision (INT12), and an unspotted pixel is regarded as unimportant and assigned with low precision (INT6).

Due to TIPS by the IPSU 500, FFN layer input may be assigned with low precision, so that mixed precision processing may be possible in the FFN layer.

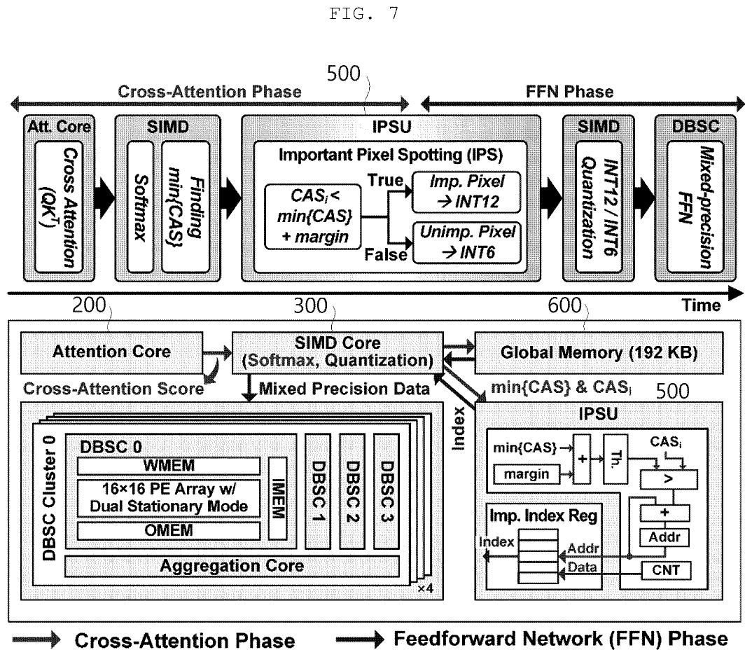

FIG. 7 illustrates cross-attention using TIPS, and a hardware data flow in the FFN layer.

In the cross-attention step, the cross-attention score is calculated in the attention core 200, and then transmitted to the SIMD core 300.

In the SIMD core 300, a softmax operation is performed and a minimum value of a subsequent CAS is derived.

The cross-attention score is transmitted to the 192 KB-global memory 600, and the CAS and the minimum CAS are transmitted to the IPSU 500. In the IPSU 500, the CAS and the minimum CAS are used to spot an important pixel.

In the FFN layer step, the SIMD core 300 performs high precision (INT12)/low precision (INT6) mixed-precision quantization using the index of the important pixel received from the IPSU 500 and the input value of the FFN layer received from the global memory 600.

The input value of the FFN layer is transmitted to the input memory IMEM 112 of each DBSC 110.

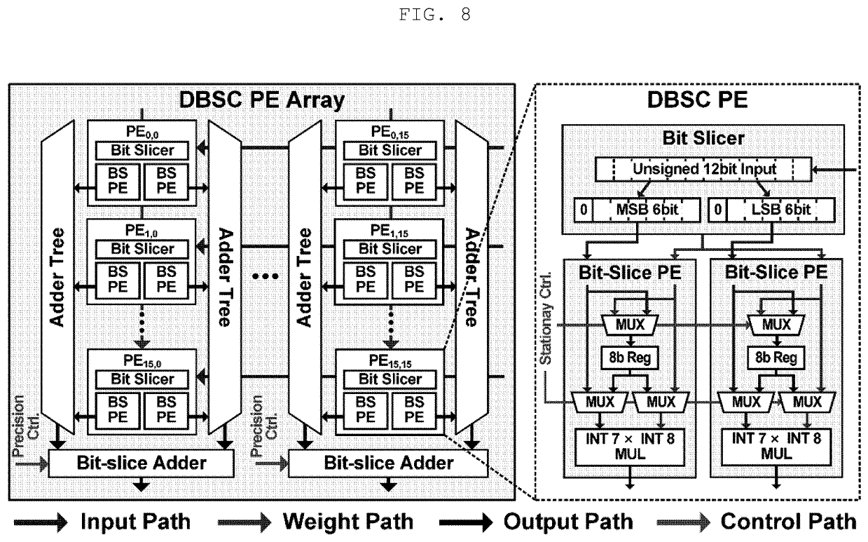

FIG. 8 illustrates an architecture of the DBSC 110. The architecture supports mixed precision operation, and optimizes data reusability in the CNN and transformer layers through input and weight-stop modes.

16 processing element PE columns are included, and each of the processing element PE columns includes 16 processing elements PES, two adder trees, and a bit-slice adder.

Each processing element PE includes a bit slicer and two bit-slice processing elements BSPEs.

The processing element PE receives 12-bit unsigned input and 8-bit signed weight, and the input is split into two 7-bit signed inputs by the bit slicer and transmitted to each of the BSPEs.

The BSPE supports both the input-stop mode and the weight-stop mode, and includes a multiplier for INT7 input and INT8 weight.

In a single processing element PE column, outputs of BSPEs in the same direction (left or right) are added in a single adder tree.

The outputs of the two adder trees in the processing element PE column are added directly or after shift, depending on whether the inputs are high-precision or low-precision.

The DBSC 110 according to the present invention increases energy efficiency of the FFN layer by 43.0% when compared to a standard assuming that all inputs are high precision (INT12).

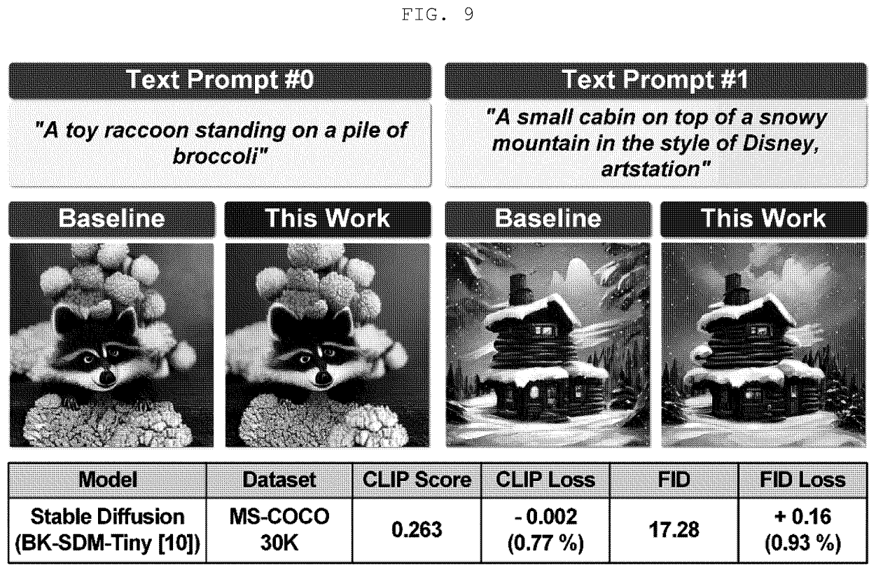

FIG. 9 illustrates results of text-based image generation by the energy-efficient diffusion model accelerator for text-based image generation according to the present invention, including generated images and benchmark evaluations. As a result of evaluation on an MS-COCO dataset, the accelerator according to the present invention successfully generated images with less than 1% CLIP loss and FID loss from given text.

The energy-efficient diffusion model accelerator for text-based image generation according to the present invention introduces a method for effectively compressing a self-attention score using similarity between adjacent patches of the self-attention score in order to solve frequent external memory access occurring due to the self-attention score. In this way, when exclusive OR (XOR) is taken between adjacent patches of self-attention scores having similar values, sparsity of the patches is augmented, and when CSR compression is applied to the patches having augmented sparsity, there are effects in that a compression rate of the self-attention score is greatly improved, and external memory access may be reduced.

The energy-efficient diffusion model accelerator for text-based image generation according to the present invention identifies similarity between text and pixels using an operation result of the cross-attention layer, spots an important pixel and an unimportant pixel based on a specific threshold of correlation, assign high bit precision to a pixel determined to be important, and assign low bit precision to a pixel determined to be unimportant, so that there is an effect that energy efficiency may be improved without loss of accuracy.

The energy-efficient diffusion model accelerator for text-based image generation according to the present invention supports mixed precision operation through bit slice operation, and employs a different operation method for each layer through a core architecture capable of supporting both input-fixed operation and weight-fixed operation, so that there is an effect that internal memory access may be reduced and operation energy efficiency may be improved.

In addition, the energy-efficient diffusion model accelerator for text-based image generation according to the present invention has effects of reducing external memory access energy by 60.3% and reducing overhead due to an index by 83.6% by augmenting sparsity of a self-attention score using patch-wise similarity of an image.

In addition, the energy-efficient diffusion model accelerator for text-based image generation according to the present invention has an effect of enabling 44.8% of input values used in calculation of an FFN layer with low precision by spotting an important pixel based on text.

In addition, in the energy-efficient diffusion model accelerator for text-based image generation according to the present invention, a DBSC architecture that supports mixed precision operation and a mixed operator fixed mode that varies depending on the layer increase energy efficiency by 43.0% in an FFN layer, so that, as a result, there is an effect of being able to achieve high energy efficiency of 28.6 mJ/iteration with only a CLIP score loss of 0.002 and an FID loss of 0.16 in an MS-COCO dataset.

Even though the technical idea of the present invention has been described above with reference to the attached drawings, this is merely an example of a preferred embodiment of the present invention and does not limit the present invention. In addition, it is clear that anyone with ordinary knowledge in the technical field to which the present invention pertains may make various modifications and imitations within the scope of the technical idea of the present invention.

What is claimed is:

1. An energy-efficient diffusion model accelerator for text-based image generation comprising:
a dual-mode bit-slice core (DBSC) cluster configured to perform operations n all linear layers included in UNet, which is a network used in a diffusion model that generates an image based on text description;
an attention core configured to perform all attention operations included in UNet;
a single instruction multiple data (SIMD ) core configured to perform activation function, on-chip quantization, and group normalization;
a patch-wise similarity-based XOR unit (PSXU) configured to compress a self-attention score;
an important pixel spotting unit configured to spot an important pixel based on given text;
a global memory configured to store an input value and an output value between adjacent layers;
a top controller configured to assign and schedule computational workloads to the DBSC cluster and the attention core; and
a network-on-chip configured to enable data movement between the DBSC clusters, the attention core, and the global memory.

2. The energy-efficient diffusion model accelerator according to claim 1, wherein UNet used for a denoising process includes a plurality of blocks and residual connections, each of the blocks includes a CNN layer and a transformer layer, the CNN layer includes two CNN layers, and the transformer layer includes a self-attention layer, a cross-attention layer, and a feed forward network layer.

3. The energy-efficient diffusion model accelerator according to claim 2, wherein, when an input feature map of the self-attention layer is converted into a query and a key, the PSXU compresses a self-attention score generated through a pixel-wise self-attention operation between one row of the query and one row of the key.

4. The energy-efficient diffusion model accelerator according to claim 3, wherein the PSXU prunes a value of the self-attention score in an unstructured manner using a predefined fixed threshold, then increases bitmap sparsity by applying XOR operation to an adjacent bitmap patch in a horizontal direction of a pruned self-attention score bitmap, and compresses the self-attention score through compressed sparse row encoding.

5. The energy-efficient diffusion model accelerator according to claim 1, wherein the PSXU comprises:
a bitmap generator unit including a plurality of bitmap generators each for generating a bitmap of predetermined bits;
a reconfigurable XOR unit (RXU) configured to generate a sparsity-augmented bitmap using the bitmap of the predetermined bits; and
a compressed sparse row encoder configured to perform compressed sparse row encoding on the sparsity-augmented bitmap.

6. The energy-efficient diffusion model accelerator according to claim 2, wherein, when an input feature map of the cross-attention layer is converted into a query and a key, the important pixel spotting unit determines a relative importance of a pixel for the text by comparing a special classification token attention score for each pixel query among the special classification token attention score and a text token attention score separated from a cross-attention result for each pixel query and text key by the cross-attention layer.

7. The energy-efficient diffusion model accelerator according to claim 6, wherein, when the special classification token attention score of the pixel query is less than a predefined threshold, the important pixel spotting unit spots the pixel as an important pixel.

8. The energy-efficient diffusion model accelerator according to claim 7, wherein, as a result of the cross-attention result, the important pixel spotting unit considers a spotted pixel important to assign the pixel with high precision and considers a pixel that is not spotted unimportant to assign the pixel with low precision.

9. The energy-efficient diffusion model accelerator according to claim 8, wherein the important pixel spotting unit assigns precision to input of the feed forward network layer by text-based important pixel spotting so that mixed-precision processing is allowed in the feed forward network layer.

10. The energy-efficient diffusion model accelerator according to claim 2, wherein a DBSC of the DBSC cluster includes a plurality of processing element columns, each of the processing element columns includes a plurality of processing elements, a plurality of adder trees, and a bit-slice adder, and both an input-stop mode and a weight-stop mode are supported according to operational characteristics of the CNN and transformer layers.
